(19) United States
(12) Patent Application Publication
(10) Pub. No.: US 2008/0180072 A1
(43) Pub. Date: Jul. 31, 2008

(54) PULSE WIDTH MODULATION (PWM) CIRCUIT AND METHOD FOR ENABLING THE SAME

(75) Inventors: Chia-Ching Lu, Hsinchu (TW); Shih-Hsuan Hsu, Hsinchu (TW); Lian-Cheng Tsai, Hsinchu (TW)

Correspondence Address: J C PATENTS, INC., 4 VENTURE, SUITE 250, IRVINE, CA, 92618, US

(73) Assignee: WINBOND ELECTRONICS CORP., Hsinchu (TW)

(21) Appl. No.: 11/735,895

(22) Filed: Apr. 16, 2007

(30) Foreign Application Priority Data
Jan. 30, 2007 (TW) 96103382

(51) Int. Cl. G05F 1/00

(52) U.S. Cl. 323/271; 323/265

(57) ABSTRACT

A pulse width modulation (PWM) circuit and a method for enabling the same are provided. The method includes the steps of: receiving a first power voltage and a second power voltage; providing a high-side driving power pin, wherein the peripheral circuit of the high-side driving power pin is adapted for generating a high-side driving voltage according to the first power voltage and the second power voltage; and enabling the PWM circuit when the high-side driving voltage is larger than the second power voltage.

### CROSS-REFERENCE TO RELATED APPLICATION

This application claims the priority benefit of Taiwan application serial no. 96103382, filed Jan. 30, 2007. All disclosure of the Taiwan application is incorporated herein by reference.

### BACKGROUND OF THE INVENTION

1. Field of the Invention

The present invention relates to an enabling circuit. More particularly, the present invention relates to a PWM circuit and a method for enabling the same.

2. Description of Related Art

PWM technology has been widely applied in various fields, especially, in power conversion circuits. Generally speaking, it is required for an ATX power supply circuit or a power supply circuit of a CPU in a computer to have a special function, which is called Power on Reset function, also referred to as Power Good function. The Power on Reset function mainly involves that the PWM circuit must detect whether one or several input voltage(s) is/are ready before the power supply circuit operates, then the power supply circuit operates after preparation is ready.

FIG. 1 is a circuit diagram of a conventional power supply circuit. Referring to FIG. 1, the circuit includes a power conversion circuit 11 and a PWM circuit 10. The PWM circuit 10 includes a power pin 101, a diode D1, a phase pin 104, a high-side driving power pin 102, a power detection pin 105, and comparators OP11, OP12. It can be noted that two powers are used in the power supply circuit, which are IC power voltage VCC and supply voltage VIN of the power conversion circuit 11 respectively.

First, the IC power voltage VCC is input to the comparator OP11 via the power pin 101. At this time, the comparator OP11 can firstly determine whether the IC power voltage VCC is larger than a reference voltage VREF_1. In another aspect, when an N-type MOS transistor QH1 is turned on, the supply voltage VIN of the power conversion circuit 11 is input into the comparator OP12 through the N-type MOS transistor QH1, a resistor R1, and a power detection pin 105. At this time, the comparator OP12 can determine whether the supply voltage VIN of the power conversion circuit 11 is larger than a reference voltage VREF_2.

When the comparator OP11 determines the IC power voltage VCC is larger than the reference voltage VREF_1, and the OP12 determines the supply voltage VIN of the power conversion circuit 11 is larger than the reference voltage VREF_2, the comparators OP11, OP12 respectively output power on reset signals POR1_1, POR2_1 to enable the PWM circuit 10, which indicates that the PWM circuit 10 detects that the preparation of the input voltage (the IC power voltage VCC and the supply voltage VIN of the power conversion circuit 11) is ready, and then the power supply circuit starts operating.

However, the PWM circuit 10 of FIG. 1 needs two pins 101, 105, two comparators OP11, OP12, and two reference voltages VREF_1, VREF_2 to detect whether the input voltages (VCC and VIN) are actually ready. The above circuit not only increases the number of the pins of the PWM circuit, but also further requires two reference voltages VREF_1, VREF_2 and two comparators OP11, OP12, so the above circuit needs an additional chip area to fabricate the comparators OP11, OP12, and needs a reference voltage generation circuit to generate VREF_1, VREF_2. Therefore, the aforementioned conventional art may cause an increase of the layout area of the circuit and require additional pins, thus easily resulting in the interference to the circuit and causing error operations.

### SUMMARY OF THE INVENTION

The present invention is directed to a PWM circuit and a method for enabling the same, so as to save the pins of the PWM circuit and reduce the use of comparators.

A PWM circuit is provided, for controlling an upper bridge switch. The upper bridge switch includes a control end, a first end, and a second end, in which the first end of the upper bridge switch is coupled to a first power voltage. The PWM circuit includes a power pin, an isolation element, a phase pin, a high-side driving power pin, and a power determination device. The power pin is used for receiving a second power voltage. One end of the isolation element is coupled to the power pin, for restricting the direction of the second power voltage. The phase pin is coupled to the second end of the upper bridge switch. The high-side driving power pin is coupled to the other end of the isolation element, for using the second power voltage to provide the driving voltage for the upper bridge switch according to the voltage of the phase pin. The power determination device is coupled to the power pin and the high-side driving power pin, for deciding whether to enable the PWM circuit by comparing the voltages of the above two pins.

A method for enabling a PWM circuit is further provided, which includes firstly receiving a first power voltage and a second power voltage by the PWM circuit; then, providing a high-side driving power pin, in which the peripheral circuit of the high-side driving power pin is adapted for generating a high-side driving voltage according to the first power voltage and the second power voltage; afterwards, when the high-side driving voltage is larger than the second power voltage, enabling the PWM circuit.

The enabling method according to a preferred embodiment of the present invention includes the steps of: firstly using a power determination device to determine whether the high-side driving voltage is larger than the second power voltage; if yes, enabling a power on reset signal; if no, disabling a power on reset signal; and finally, deciding whether to enable the PWM circuit according to the enable/disable of the power on reset signal.

The present invention utilizes the input function of a high-side driving power pin of a PWM circuit to detect whether a first power voltage and a second power voltage exist, and uses a power determination device to determine whether to output a power on reset signal, so as to decide whether to enable the PWM circuit.

In order to make the aforementioned and other objectives, features, and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional power supply circuit.

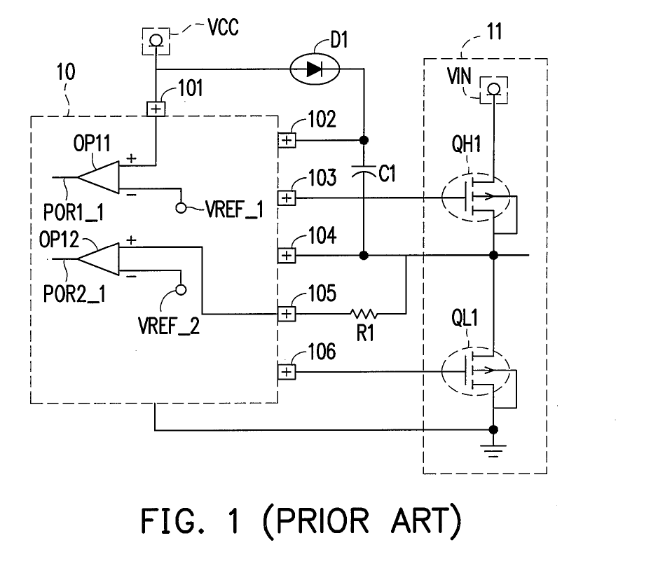

FIG. 2 is a circuit diagram of a power supply circuit according to an embodiment of the present invention.

FIG. 3 is a circuit diagram of a PWM circuit and a power supply circuit using the same according to another embodiment of the present invention.

FIG. 4 is a flow chart of a method for enabling a PWM circuit according to this embodiment.

### DESCRIPTION OF EMBODIMENTS

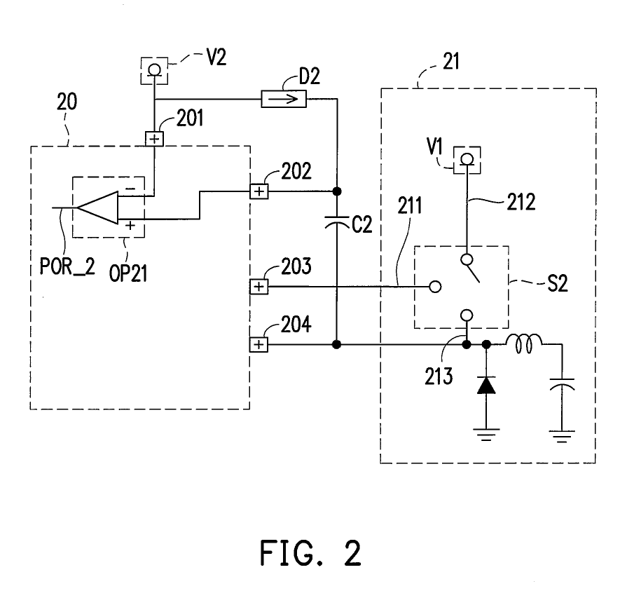

FIG. 2 is a circuit diagram of a power supply circuit according to an embodiment of the present invention. Referring to FIG. 2, the power supply circuit includes a buck circuit 21 and a PWM circuit 20 of an embodiment of the present invention. The buck circuit 21 includes an upper bridge switch S2 which has a control end 211, a first end 212, and a second end 213. The first end 212 of the upper bridge switch is coupled to a first power voltage V1. The PWM circuit 20 includes a power pin 201, an isolation element D2, a phase pin 204, a high-side driving power pin 202, an upper bridge pin 203, and a power determination device OP21.

The circuit operation of this embodiment is briefly illustrated as follows. First, a second power voltage V2 charges a capacitor C2 via the isolation element D2 (for example, diode) until reaching the second power voltage V2, and meanwhile the high-side driving power pin 202 can first detect whether the voltage level is the second power voltage V2. When the upper bridge switch S2 is conducted, the voltage of the high-side driving power pin 202 equals (V2+V1—the voltage drop between the first end 212 and the second end 213 of the upper bridge switch S2). As the negative end of the power determination device OP21 inside the PWM circuit 20 is coupled to the power pin 201, the positive end thereof is coupled to the high-side driving power pin 202, when the voltage on the high-side driving power pin 202 is larger than the second power voltage V2, it indicates that the first power voltage V1 and the second power voltage V2 are ready. Therefore, in this embodiment, through the high-side driving power pin 202, it can be determined whether the first, second power voltages V1, V2 are ready.

If the voltage of the high-side driving power pin 202 is larger than the voltage of the power pin 201, the power determination device OP21 enables a power on reset signal POR_2, so as to enable the PWM circuit 20 to make the power supply circuit start operating. If the voltage of the high-side driving power pin 202 is smaller than the voltage of the power pin 201, it indicates that the input voltages (the first power voltage V1 and the second power voltage V2) are not ready, and the power determination device OP21 disables a power on reset signal POR_2. At this time, the PWM circuit 20 is not enabled, and the power supply circuit does not operate.

Compared with the conventional circuit, the circuit of the above embodiment only needs one pin to detect the power and one comparator to determine the magnitude of the voltage. However, the conventional circuit requires one more pin and one more comparator to detect whether the power is ready. Further, the conventional circuit needs two reference voltages VREF_1 and VREF_2, and two reference voltages to generate a circuit. Obviously, compared with the conventional art, the embodiment implemented based on the spirit of the present invention can save many unnecessary elements, reduce unnecessary costs, and reduce the number of the pins of an IC.

Those skilled in the art should understand that in the above embodiment, the power supply circuit is not limited to the buck circuit 21, but can also be a boost circuit or a boost/buck circuit as required.

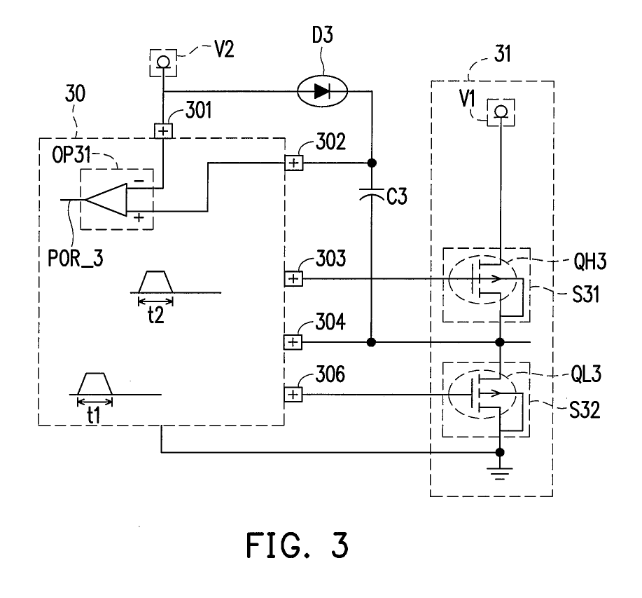

FIG. 3 is a circuit diagram of a PWM circuit and a power supply circuit using the same according to another embodiment of the present invention. In this embodiment, an upper bridge switch S31 and a lower bridge switch S32 are respectively implemented by N-type MOS transistors QH3, QL3. The isolation element D2 is implemented by a diode D3. Referring to FIG. 3, the power supply circuit includes a power conversion circuit 31 and a PWM circuit 30. The power conversion circuit 31 includes N-type MOS transistors QH3, QL3, in which the drain of the N-type MOS transistor QH3 is coupled to the first power voltage V1. The PWM circuit 30 includes a power pin 301, an isolation element D3, a phase pin 304, a high-side driving power pin 302, an upper bridge pin 303, a lower bridge pin 306, and a power determination device OP31.

The PWM circuit 30 of FIG. 3 is achieved according to the following concepts.

1. At a time t1, the lower bridge pin 306 of the PWM circuit 30 provides a PWM signal to the gate of the N-type MOS transistor QL3, and turns on the N-type MOS transistor QL3. At this time, the second power voltage V2 charges the capacitor C3 via the diode D3, such that the voltage between the high-side driving power pin 302 and the phase pin 304 is the second power voltage V2. Moreover, it can be firstly detected in the PWM circuit 30 whether the voltage level of the high-side driving power pin 302 is the second power voltage V2.

2. At a time t2, the upper bridge pin 303 of the PWM circuit 30 provides a high-side driving voltage to the gate of the N-type MOS transistor QH3, and makes the N-type MOS transistor QH3 turned on. At this time, the voltage of the phase pin 304 is (the first power voltage V1—the voltage drop between the drain and the source of the N-type MOS transistor QH3), so the voltage of the high-side driving power pin 302 ideally equals (V2+V1—the voltage drop between the drain and the source of the QH3). As the negative end of the power determination device OP31 in the PWM circuit 30 is coupled to the power pin 301, the positive end thereof is coupled to the high-side driving power pin 302, so as to determine whether there is a difference between the high-side driving voltage (the voltage of the high-side driving power pin 302) and the first power voltage V1 or whether the high-side driving voltage is higher than the second power voltage V2.

If it is determined that there is a difference between the high-side driving voltage and the first power voltage V1 or the high-side driving voltage is higher than the second power voltage V2 the power determination device OP31 enables a power on reset signal POR_3, so as to enable the PWM circuit 30, which indicates that the PWM circuit 30 detects the input voltages (both the first power voltage V1 and the second power voltage V2) are ready and the power supply circuit can start operating. If it is determined that there is no difference between the high-side driving voltage and the first power voltage V1 or the high-side driving voltage is lower than the second power voltage V2, the power determination device OP31 disables a power on reset signal POR_3, and meanwhile the PWM circuit 30 is not enabled, which indicates that the PWM circuit 30 detects the input voltages (both the first power voltage V1 and the second power voltage V2) are not ready, and the power supply circuit does not operate.

Those skilled in the art should understand that the power determination device OP31 in the above embodiment can be implemented by a comparator or an operational amplifier. The upper bridge switch QH3 and the lower bridge switch QL3 in the above embodiment can be implemented by P-type MOS transistors or bipolar junction transistors (BJTs). The isolation element D3 in the above embodiment can be implemented by an MOS transistor or a BJT. The present invention is not limited herein.

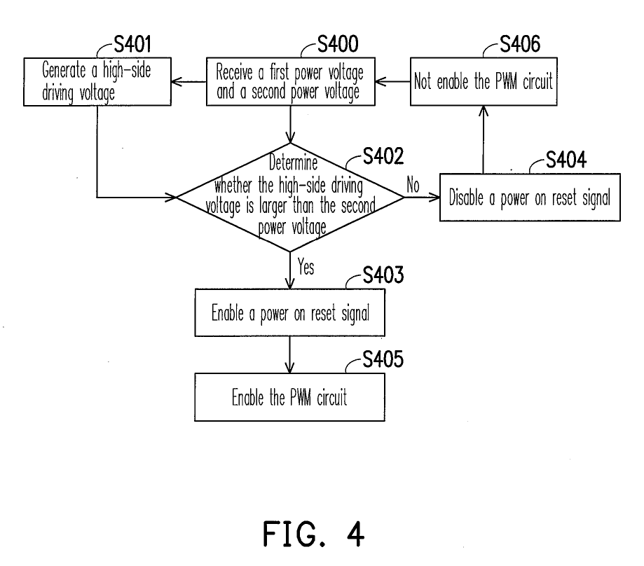

FIG. 4 is a flow chart of a method for enabling a PWM circuit according to this embodiment. The method includes the steps of: firstly receiving a first power voltage and a second power voltage by the PWM circuit (Step S400); then providing a high-side driving power pin by the PWM circuit, in which the peripheral circuit of the high-side driving power pin is adapted for generating a high-side driving voltage according to the first power voltage and the second power voltage (Step S401); and then using a power determination device to determine whether the high-side driving voltage is larger than the second power voltage (Step S402).

If it is determined that the high-side driving voltage is larger than the second power voltage, a power on reset signal is enabled by the power determination device (Step S403) and then transmitted to the PWM circuit. Upon receiving the power on reset signal enabled by the power determination device, the PWM circuit is enabled (Step S405). If it is determined that the high-side driving voltage is smaller than the second power voltage, a power on reset signal is disabled by the power determination device (Step S404) and then transmitted to the PWM circuit. When receiving the power on reset signal disabled by the power determination device, the PWM circuit is not enabled (Step S406). Then, the process returns to Step S400, and is repeated until the PWM circuit is enabled (Step S405).

It should be noted that though the described embodiment of a PWM circuit, a method for enabling the same, and a power supply circuit using the same is described in the above embodiment, those of ordinary skill in the art should understand that the manufacturers have different designs of the power conversion circuit 31 and the PWM circuit 30, so the application of the present invention is not limited to the above-described embodiment. In other words, it conforms to the spirit of the present invention as long as the high-side driving power pin of the PWM circuit 30 detects the first power voltage V1 and the second power voltage V2, and a power determination device OP31 is also used to determine whether to output a power on reset signal POR_3 to decide whether to enable the PWM circuit 30.

In view of the above, the present invention adopts the input function of a high-side driving power pin and a power determination device of a PWM circuit to detect whether the first power voltage and the second power voltage are ready, and determine whether to output a power on reset signal, so as to decide whether to enable the PWM circuit and whether the power supply circuit starts operating. Thus, not only the number of the pins of the PWM circuit is saved, but also no additional chip is required to fabricate extra comparators and reference voltage generation circuits to provide a reference voltage. Thus, the circuit layout area can be reduced and the circuit cost is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pulse width modulation (PWM) circuit, for controlling an upper bridge switch having a control end, a first end, and a second end, wherein the first end of the upper bridge switch is coupled to a first power voltage, the PWM circuit comprising:
a power pin, for receiving a second power voltage;
an isolation element, with one end coupled to the power pin, for restricting the direction of the second power voltage;
a phase pin, coupled to the second end of the upper bridge switch;
a high-side driving power pin, coupled to the other end of the isolation element, for utilizing the second power voltage to provide the driving voltage for the upper bridge switch according to the voltage of the phase pin; and
a power determination device, coupled to the power pin and the high-side driving power pin, for deciding whether to enable the PWM circuit by comparing the voltage of the high-side driving power pin and the voltage of the power pin.

2. The PWM circuit as claimed in claim 1, wherein the power determination device comprises:
an amplifier, with a negative end coupled to the power pin and a positive end coupled to the high-side driving power pin, for determining whether the voltage of the high-side driving power pin is larger than the voltage of the power pin, so as to decide whether to output a power on reset signal.

3. The PWM circuit as claimed in claim 1, wherein the high-side driving power pin utilizes the second power voltage to generate a high-side driving voltage according to the voltage of the phase pin, and the PWM circuit further comprises:
an upper bridge pin, coupled to the control end of the upper bridge switch, for deciding the on/off of the upper bridge switch according to the high-side driving voltage.

4. The PWM circuit as claimed in claim 1, wherein the PWM circuit is further used to control a lower bridge switch, and the PWM circuit further comprises:
a lower bridge pin, coupled to the control end of the lower bridge switch, for deciding the on/off of the lower bridge switch according to a PWM signal.

5. The PWM circuit as claimed in claim 1, wherein the upper bridge switch or the lower bridge switch is an N-type MOS transistor, a P-type MOS transistor, or a bipolar junction transistor (BJT).

6. The PWM circuit as claimed in claim 1, wherein the isolation element is a diode, an MOS transistor, or a BJT.

7. A method for enabling the PWM circuit, comprising:
receiving a first power voltage and a second power voltage;
providing a high-side driving power pin, wherein the peripheral circuit of the high-side driving power pin is adapted for generating a high-side driving voltage according to the first power voltage and the second power voltage; and
when the high-side driving voltage is larger than the second power voltage, enabling the PWM circuit.

8. The method for enabling the PWM circuit as claimed in claim 7, wherein the step of when the high-side driving voltage is larger than the second power voltage, enabling the PWM circuit comprises:
determining whether the high-side driving voltage is larger than the second power voltage;
if yes, enabling a power on reset signal;
if no, disabling a power on reset signal; and
deciding whether to enable the PWM circuit according to the power on reset signal.
